(19) United States
(12) Patent Application Publication
(10) Pub. No.: US 2013/0080520 A1
(43) Pub. Date: Mar. 28, 2013

(54) METHOD AND APPARATUS FOR PROVISIONING RESOURCE CREDENTIALS BASED ON SOCIAL NETWORKING DATA

(71) Applicants: Niko Tapani Kiukkonen, Veikkola (FI); Janne Marin, Espoo (FI); Jukka Pekka Reunamäki, Tampere (FI); Sverre Slotte, Esbo (FI)

(72) Inventors: Niko Tapani Kiukkonen, Veikkola (FI); Janne Marin, Espoo (FI); Jukka Pekka Reunamäki, Tampere (FI); Sverre Slotte, Esbo (FI)

(73) Assignee: Nokia Corporation, Espoo (FI)

(21) Appl. No.: 13/240,310

(22) Filed: Sep. 22, 2011

(51) Int. Cl. G06F 15/16

(52) U.S. Cl. 709/204

(57) ABSTRACT

An approach for automating the provisioning of access credentials related to one or more shared resources to one or more user devices. An access rights platform determines one or more resources associated with at least one user, at least one device associated with the at least one user, or a combination thereof. The platform also processes social networking information associated with the at least one user, the at least one device, or a combination thereof to determine one or more social networking groups to which the one or more resources are associated. One or more access rights to the one or more resources for one or more other devices based, at least in part, on membership in the respective one or more social networking groups is then determined.

### BACKGROUND

Service providers and device manufacturers (e.g., wireless, cellular, etc.) are continually challenged to deliver value and convenience to consumers. This includes, for example, providing compelling network services for enabling mobile device users to share their network resources with friends. By way of example, a user may wish to allow designated users to access their wireless access point (WAP), designated file servers or other resources when those users are determined to be within range of the WAP or data source. Typically, this is accomplished by manual configuration means, including requiring the designated users to enter a password, network identifier, security key and other access credentials to gain access to the resource. This process is time consuming and prone to error due to manual entry. Furthermore, the configuration process is more complex when a number of different device users require access to the same or multiple different shared resources, all of which may require different access credentials. Unfortunately, there is currently no convenient, secure means of automating the provisioning of access credentials related to one or more shared resources for use by one or more user devices.

### SOME EXAMPLE EMBODIMENTS

Therefore, there is a need for an approach for automating the provisioning of access credentials related to one or more shared resources to one or more user devices.

According to one embodiment, a method comprises determining one or more resources associated with at least one user, at least one device associated with the at least one user, or a combination thereof. The method also comprises processing and/or facilitating a processing of social networking information associated with the at least one user, the at least one device, or a combination thereof to determine one or more social networking groups. The method also comprises causing, at least in part, an association of the one or more resources with the one or more social networking groups. The method further comprises determining one or more access rights to the one or more resources for one or more other devices based, at least in part, on membership in the respective one or more social networking groups.

According to another embodiment, an apparatus comprises at least one processor, and at least one memory including computer program code for one or more computer programs, the at least one memory and the computer program code configured to, with the at least one processor, cause, at least in part, the apparatus to determine one or more resources associated with at least one user, at least one device associated with the at least one user, or a combination thereof. The apparatus is also caused to process and/or facilitate a processing of social networking information associated with the at least one user, the at least one device, or a combination thereof to determine one or more social networking groups. The apparatus is also caused to associate one or more resources with the one or more social networking groups. The apparatus is further caused to determine one or more access rights to the one or more resources for one or more other devices based, at least in part, on membership in the respective one or more social networking groups.

According to another embodiment, a computer-readable storage medium carries one or more sequences of one or more instructions which, when executed by one or more processors, cause, at least in part, an apparatus to determine one or more resources associated with at least one user, at least one device associated with the at least one user, or a combination thereof. The apparatus is also caused to process and/or facilitate a processing of social networking information associated with the at least one user, the at least one device, or a combination thereof to determine one or more social networking groups. The apparatus is also caused to cause, at least in part, an association of the one or more resources with the one or more social networking groups. The apparatus is further caused to determine one or more access rights to the one or more resources for one or more other devices based, at least in part, on membership in the respective one or more social networking groups.

According to another embodiment, an apparatus comprises means for determining one or more resources associated with at least one user, at least one device associated with the at least one user, or a combination thereof. The apparatus also comprises means for processing and/or facilitating a processing of social networking information associated with the at least one user, the at least one device, or a combination thereof to determine one or more social networking groups. The apparatus also comprises means for causing, at least in part, an association of the one or more resources with the one or more social networking groups. The apparatus further comprises means for determining one or more access rights to the one or more resources for one or more other devices based, at least in part, on membership in the respective one or more social networking groups.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-9, 21-29, and 44-46.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of automating the provisioning of access credentials related to one or more shared resources for one or more user devices, according to one embodiment;

FIG. 2A is a diagram of the components of an access rights platform, according to one embodiment;

FIG. 2B is a diagram of a data structure of access point data maintained by the access rights platform, according to one embodiment;

FIGS. 3A-3C are flowcharts of a process for automating the provisioning of access credentials related to one or more shared resources for one or more user devices, according to various embodiments;

FIGS. 4A-4D are diagrams of user interfaces utilized in the processes of FIGS. 3A-3C, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for automating the provisioning of access credentials related to one or more shared resources to one or more user devices are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

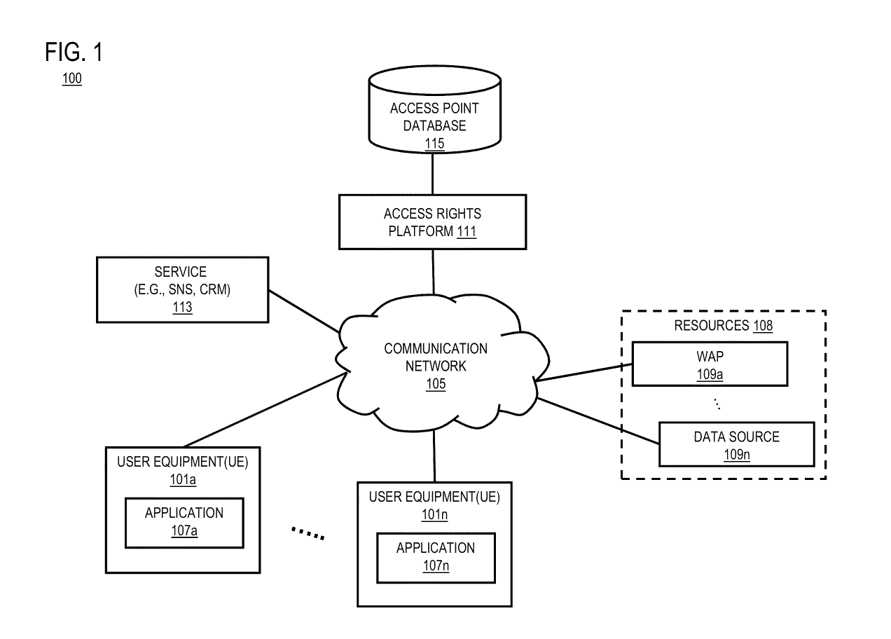

FIG. 1 is a diagram of a system capable of automating the provisioning of access credentials related to one or more shared resources for one or more user devices, according to one embodiment. By way of example, the system 100 is configured to enable one or more user devices, i.e., user equipment (UE) 101a-101n, to receive and process resource access credentials on the basis of an affiliation with a host of said resources. At least one user of the various UE 101a-101n serves as a host that enables the specification of one or more resources 108 to be shared with one or more other UEs 101. Resources made available by the host may include, for example, one or more wireless access points 109a, a data source 109n for maintaining one or more data files, one or more executables (e.g., applications or web services), or a combination thereof.

Typically, resources accessed via a communication network are procured on a secure and/or permission basis, with the access or permission being enabled according to one or more access rights. Access rights are granted to only those users that have the proper credentials for entry, thus preventing unwanted users from gaining access to the resource. In addition, the determined access rights may also establish the limits of use of the resources by those permitted access to the resource. By way of example, a company serving as a host may wish to only permit employees of their company to access a wireless access point (WAP) while preventing access to non-employees. As another example, only those employees designated as executives of the company may be allowed access to sensitive data files maintained in a proprietary server. Under this scenario, the access rights granted the executive employees is greater than that of the non-executive employees on the basis of identifiable criteria, while entry to the resource is based on the one or more access credentials.

Typically, access credentials may include, for example, any information required to enable a user device to gain access to, locate, activate and/or otherwise gain control of a resource designated for sharing. The credentials are entered by a requesting user at an interface, gateway, object or other entry mechanism of the resource and/or at the resource directly. This may include, for example, entry of a password, network identifier, security key, resource locator, or a combination thereof. The host must establish and provide the access credentials to each user they want to share a resource with. Unfortunately, this task is both time consuming and complex especially as the number of users to share the resource with increases. Also, this process is further compounded in cases where the host wishes to share multiple different resources with various other users, each of which may require a different set of credentials to be configured and provided. Still further, the access credentials are typically entered on a manual data entry basis, making the configuring of such credentials prone to error.

To address this problem, system 100 of FIG. 1 introduces the capability to automate the process for providing, to one or more UE 101a-101n, one or more access credentials. The access credentials include information for enabling the UE 101a-101n to gain use of or control over resources 108, which may include for example, a wireless access point 109a or data source 109n. The resources 108 may be dispersed about a communication network 105 at varying locations or access points, i.e., as referenced by a resource locator, internet protocol address, etc. By way of example, an access rights platform 111 enables provisioning of the one or more access credentials based, at least in part, on a determination that users of UE 101a-101n are associated with one or more social networking groups of the host. It is noted that provisioning may include a configuring of access credentials, a transmission of one or more access credentials, a populating of one or more access credentials to one or more credential entry fields, etc.

The host of the one or more resources 108 interacts with the access rights platform 111 to specify the one or more users and/or UE 101a-101n having access rights to the resources 108. In certain embodiments, the access rights platform 111 maintains an access point database 115 of the various users and/or UE 101a-101n having access to the resource 108 as well as the access point identifiers, related passwords, user rights (e.g., a level or extent of use or access to a resource) and other like data. The database 115 includes any information required for gaining entry to or use of the resources 108 by a user in accordance with the user's appropriated access rights. Hence, while the access rights correspond to an extent of use of resources 108, the access credentials correspond to the ability of a given user to access the resources 108.

By way of example, the host may configure a first user of UE 101a and second user of UE 101n with different access rights. The first user may be assigned access rights for enabling direct control over the WAP 109a and the data source 109n, while the second user is only given access rights for accessing of the data source 109n. Alternatively, the host may specify that both the first and second user have access to the WAP 109a and data source 109n but that only the second user is allowed to access certain sensitive files maintained at the source 109n. Still further, in certain instances, access credentials (i.e., password, access key) for gaining entry to the resources 108 may be established by the host and provided to the users to be used in connection with a specified login name or identifier. It is noted that different access credentials, such as a different password, may be specified for the first and second user regarding the same resource 108 in certain security implementations. The access rights platform 111 accounts for any implementation.

The platform 111 renders a configuration interface to a display of UE 101 of the host for enabling the configuring of access credentials and the establishing of access rights. For example, the user may specify a list of users and/or groups thereof to be permitted access to a specific resource. Likewise, the host may indicate a specific set of credentials required by the users and/or groups to enable access, such as a resource locator or password. It is noted that the access credentials may be customized by the host, established by the manufacturer of the resource, or a combination thereof. For example, the host may specify a password for accessing of a WAP while a hardware key and/or access key is specified by the manufacturer.

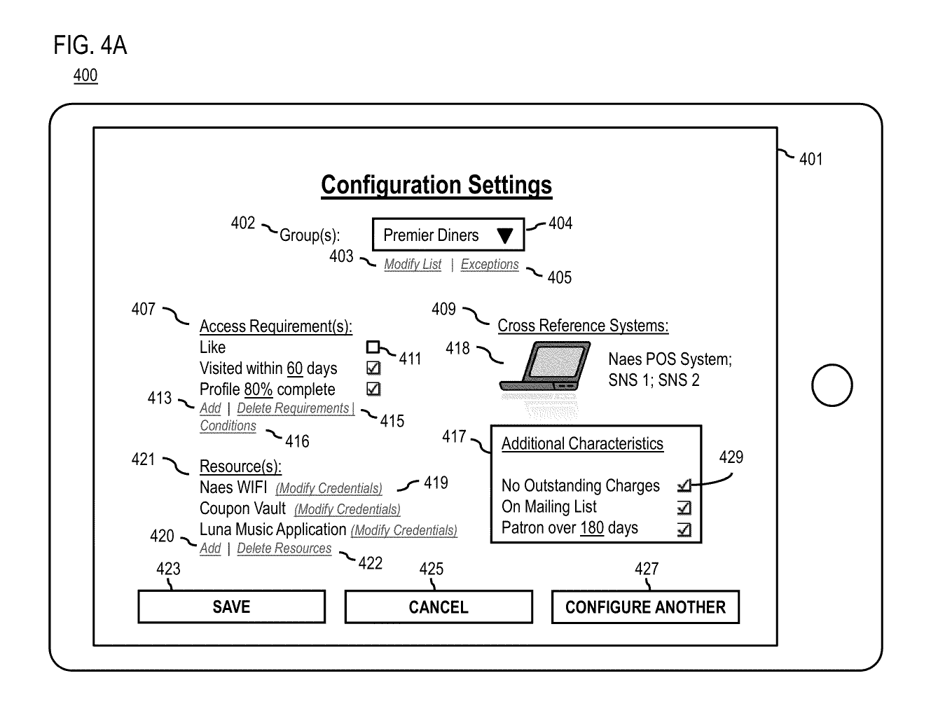

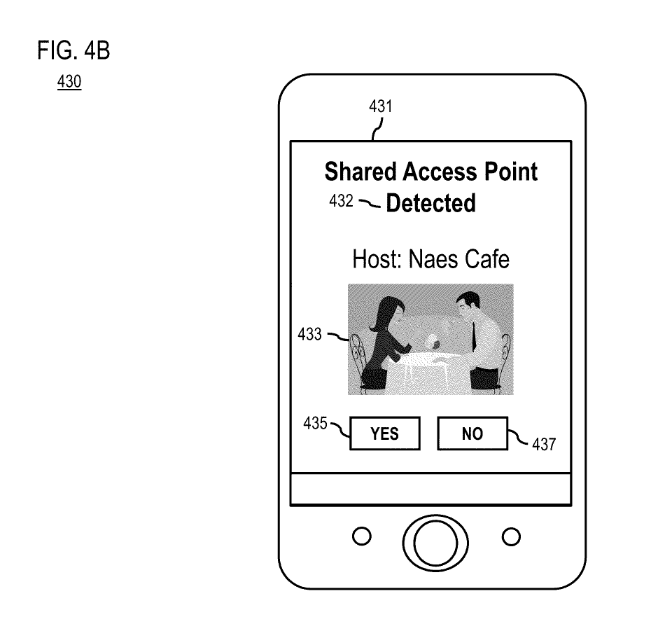

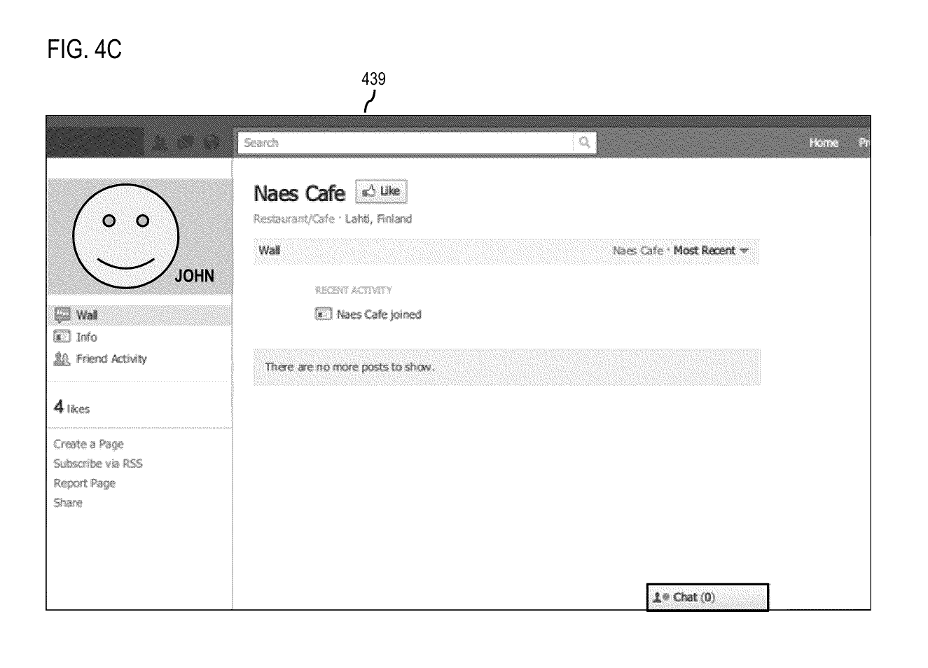

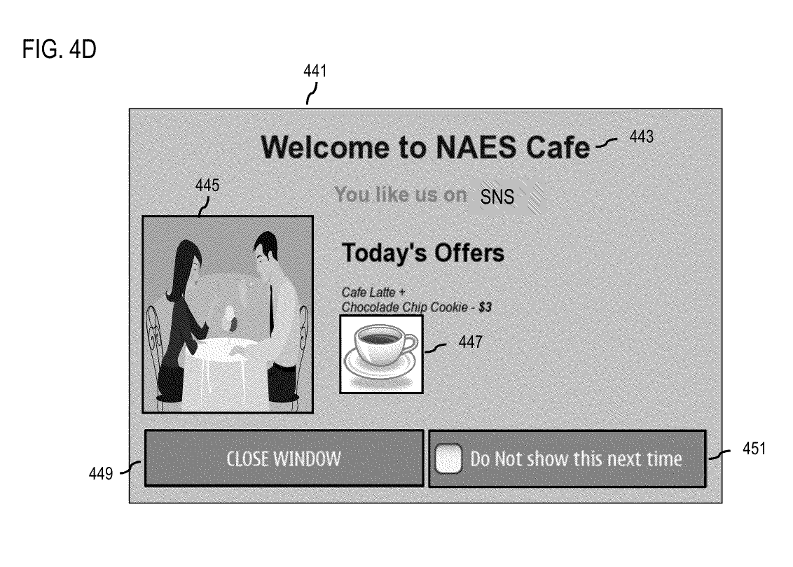

In addition, the user may select via the interface, one or more controls for affecting the level of access to the one or more resources 108 by individual users, groups of users, or a combination thereof. For example, a group of users selected by the host as having access to a logistics database may be allowed access to all data. An exception may be made for at least one group member, however, to limit that member access to a select number of files. It is noted in certain embodiments that the access rights platform 111 enables the host to preselect the one or more resources to be shared as well as update access credentials for individual users and/or groups thereof in response to changing conditions. More regarding the configuration interface is presented later on with respect to FIG. 4A.

In certain embodiments, the access rights platform 111 interacts with a service 113 such as a social networking service (SNS), customer resource management (CRM) service, directory service, or any other service for maintaining data regarding one or more users (e.g., contacts) associated with the host. The service 113 may be used by the access rights platform 111 for cross referencing one or more users requesting access to a resource against the users and resources specified for access by the host. For the purpose of illustration, the service 113 is presented from the perspective of a SNS (e.g., Facebook, MySpace, Linkedln).

The SNS 113 maintains a listing of various members, social networking group affiliations of said members, or a combination thereof as related to the host. Each member of the SNS 113 registers with the service provider of the SNS by creating a profile for specifying personal details, interests, information sharing restrictions, marketing preferences, etc. In addition, the members are assigned or create a user name, a login password, a security question and the like as access credentials for the SNS 113. As a registered member, the host may communicate with the various other members of the SNS 113 as well, including transmitting communication messages, notification messages, shared event notifications, chat requests, playing games, exchanging files, etc.

Still further, the host may be associated with other members via group affiliation, i.e., a group comprising one or more other members of the SNS 113. For example, a group entitled the “Bell City Engineering Crew” may be formed at the SNS 113 for supporting sharing of information between Engineers residing in a common location based on their common interests. In this example, the host may interact exclusively with members of this group to engage in discussions regarding engineering related projects and events. Similarly, other interest groups may also be associated with the host, where the participating other members represent a portion of the entire list of members associated with the host. Alternatively, a group may also include the overall list of members (contacts) associated with the specific profile of the host. It is noted, therefore, that a group may include an overall/global listing of all members associated with the host or a sub-grouping of members representing only a portion of the overall/global listing.

The host communicates with and recognizes various other members of the SNS 113 by way of social networking information, including a username, alias, group reference, user reference, icon or other identifier. Other social networking information specified by members may include a satisfaction rating attributed to the host (e.g., a Like or Dislike indicator), a satisfaction rating attributed to a group affiliation of the host, a frequency of communication with the host (e.g., a first time visitor, frequent collaborator), a guest rating as set by the host (e.g., an indication of the effectiveness of the guest in conveying information), or a combination thereof. It is noted that the social networking information includes that which is specified by the host regarding the one or more other members, that which is specified by the one or more other members relative to the host, or a combination thereof.

In certain embodiments, the access rights platform 111 relies upon the SNS 113 to verify and/or authenticate a user and/or UE 101 as belonging to a social networking group flagged for provisioning of access credentials for a given resource 108. Under this approach, the access rights platform 111 is able to readily cross reference requesting users of UE 101a-101n against one or more groups specified by the host to access the resources 108 based on one or more access rights. A request for access by a given user of UE 101 for access to a resource 108 is facilitated by way of a detecting of the resource, a logging into the resource, a visiting of a network location for the resource, etc. For example, a request is initiated by the detection of WAP 109a by UE 101a.

The user equipment of the host connects to the access rights platform 111 by conveying social networking information related to the host such as a login name or other identifier. In certain embodiments, the social networking service is accessed by way of an application 107a-107n resident at respective user equipment 101a-101n. The application 107a-107n may also be implemented as a web browser or portal application for accessing the access rights platform 111, the service 113 and/or one or more resources 108. As will be discussed more fully later on, in the case of the UE 101 of a host, the application 107a-107n may also be used to render a configuration interface for establishing various shared resource settings.

The access rights platform 111 utilizes the social networking information as entered to authenticate the user against the social networking service 113. The authentication process may include determining an ability of the user device to actually login and access the host's SNS profile page based on the provided social networking information. In addition, the authentication process may include monitoring of the status of the current friend lists (e.g., in the case of a private wireless access point), members of a group, fans of a page, or users who associated with the host. By monitoring the list of members indicated as friends as well as group affiliation with the host, the access rights platform 111 is able to associate users (members) with resources 108 accordingly.

Furthermore, the access rights platform 111 determines what access rights are made available to the one or more members of an associated group. Access rights may be based, for example, on whether a relationship identifier, group identifier, a satisfaction rating attributed to the at least one user, a satisfaction rating attributed to the one or more social networking groups, a frequency of communication with the at least one user, or a combination thereof matches a criteria required for satisfying the access rights. For example, the access rights for individual members of a group may vary depending on a ‘Like’ rating, quality rating or other indicator specified for the host by the member via the SNS 113. In other instances, the indicator may relate to a level of closeness, familiarity or priority of the host relative to the member. It is noted that the host of the resource may be an individual person, a group, a company or organization, a website, etc.

When the access rights are confirmed, the platform 113 then provisions the access point data to the one or more users of UE 101a-101n with access credentials associated with the one or more resources 108. The provisioning is done utilizing existing mechanisms implemented in the mobile devices for remotely managing and configuring the resources 108. For example, the access credentials may be pushed to UE 101a-101n by way of a push service, synchronized at the UE 101a-101n via a synchronization service with the access rights platform 111, etc. It is noted that provisioning of the credentials enables the UE 101a-101n to access the one or more resources 108 when a request for access to the resource 108 is made. By way of example, when the user of UE 101a is within range of a shared WAP 109a, the one or more access credentials for engaging the resource 108 are automatically uploaded to the resource and/or pushed to the device for uploading. Alternatively, the provisioning may occur based on the detecting of a condition, such as a determined proximity threshold being met by the UE 101a, a determined activity being performed by the user, etc.

While the aforementioned examples pertain to different users of different UEs 101a-101n, the access rights platform 111 may also support provisioning of access credentials for multiple different UE 101 of a single user. For example, a user that employs a cell phone, tablet computer and laptop computer may access the platform 111 to configure each of the different devices with access credentials for a newly installed WAP. As such, the user does not have to enter the access credentials for the WAP into each device individually.

Still further, access rights platform 114 may be used to configure one or more user equipment 101a-101n with access credentials for enabling mobile web services, peer-to-peer communication, automated script runs, software updating, etc. For example, the access rights platform 111 may configure one or more UE 101a-101n with access credentials for accessing a mobile web service as hosted by a user device of the host. Once configured, the UE 101a-101n can automatically establish a peer-to-peer or ad-hoc network. As another example, access credentials for accessing a data source that maintains a software patch can be automatically uploaded to commence the installation at each UE 101a-101n.

As shown in FIG. 1, the system 100 comprises a user equipment (UE) 101 having connectivity to an access rights platform 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, service 113 and access rights platform 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

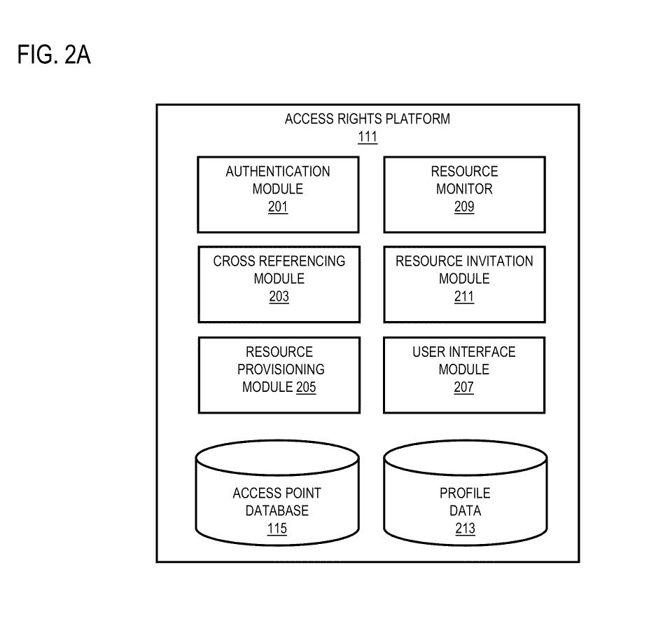

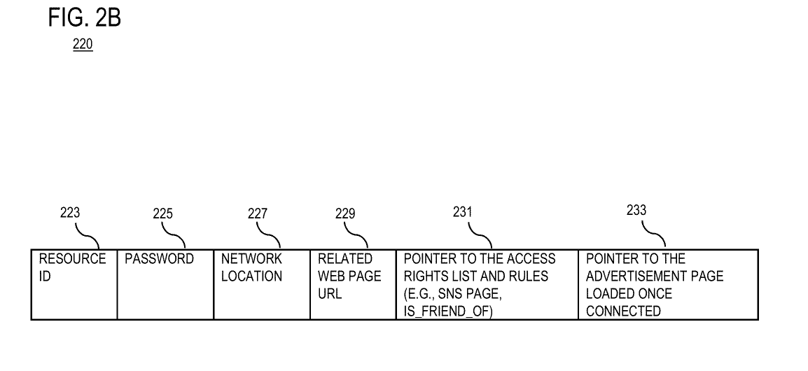

FIG. 2A is a diagram of the components of an access rights platform, according to one embodiment. By way of example, the access rights platform 111 includes one or more components for automating the provisioning of access credentials related to one or more shared resources for one or more user devices. It is contemplated that the functions of these components may be combined in one or more components or performed by other components of equivalent functionality. In this embodiment, the access rights platform 111 includes an authentication module 201, cross referencing module 203, resource provisioning module 205, user interface module 207, resource monitor 209 and resource invitation module 211.

In addition, the platform 111 also maintains access point database 115 for housing data regarding the various access rights, resource information, credential data, etc. A profile database 213 is also maintained for maintaining user and/or device information and subscription data pertaining to a host of one or more resources.

In one embodiment, the authentication module 201 authenticates users and user devices 101a-101n for interaction with the access rights platform 111. By way of example, the authentication module 201 receives a request to subscribe to the platform 111 to enable the provisioning of access credentials for entry and/or use of various resources associated with the user. The subscription process may include enabling the specification of various resources as well as preferred levels of access of said resources. Preferences and settings information may be referenced to a specific user, user device, or combination thereof and maintained as profile data 213.

The authentication process performed by the module 201 may also include receiving and validating a login name and/or user identification value as provided or established for a particular user (host) during a subscription or registration process with a provider of the access rights platform 111. The login name and/or user identification value may be received as input provided by the user from the user device 101 or other device via a graphical user interface to the platform 111 (e.g., as enabled by user interface module 207). Profile data 213 for respective subscribers may be cross referenced as part of the login process. Alternatively, the login process may be performed through automated association of profile settings maintained as registration data with an IP address, a carrier detection signal of a user device, mobile directory number (MDN), subscriber identity module (SIM) (e.g., of a SIM card), radio frequency identifier (RFID) tag or other identifier.

The authentication module 201 also operates in connection with a cross referencing module 203 to perform authentication of one or more user devices with respect to the host. This includes, for example, determining whether a particular user device requesting access to a shared resource matches any of the one or more users and/or groups identified at a social networking service of the host. The cross referencing module 203 accesses the social networking service in response to (1) a detected initial registration with the access rights platform 111 by the host user device; (2) an update request by the host; (3) or a first time accessing of a resource by the host user device. It is noted that the cross referencing module may be configured to access multiple social networking sites, customer relationship management servers and other services for enabling the determination/authentication process to be performed. It is also contemplated in future embodiments, that the cross referencing module 203 may be configured to account for duplicate group entries or even support merged grouping of members from different services.

In one embodiment, the resource provisioning module 205 enables a user to select one or more resources to be shared along with the one or more groups associated with the host to be given access to the resources. The module 205 also enables the host to establish or define the one or more access rights to be assigned to group members for accessing the resources. The resource provisioning module may receive data from a configuration interface provided by the user interface module for defining the access rights, the resources involved, etc. By way of example, the resource provisioning module 205 may receive and process input for indicating a WAP resource to be associated with a study group of the host. In addition, the module 205 may receive and process input for indicating one or more conditions for enabling access of the WAP, including proximity based conditions, a current rating or indicator attributed by the user to the host via the social networking service, etc.

In another embodiment, the resource monitor 209 operates in connection with the user interface module 207 to receive input for indicating one or more access credentials relating on a specified shared resource by the host. The input may include a password or key associated with the resource. The monitor 209 conveys this information to the cross referencing module 205 as well as the resource provisioning module 205 for supporting cross-referencing of users and validating of resource access based on defined access rights. Still further, the resource monitor 209 is also configured to periodically monitor the one or more specified resources to determine any updates to one or more access credentials. By way of example, the monitor 209 may determine a new network location of a wireless access point, such as resulting from the relocating of a user to a new building. In monitoring this update, the access credentials for all devices associated with the WAP resource is corrected and provisioned to the various devices assigned to the resource.

In one embodiment, the resource invitation module 211 is configured to generate notification messages for inviting the host to add and/or update a shared resource. The resource invitation module 211 operates in connection with the resource provisioning module 205 to determine or detect a first time use of a resource by the host or first time indication of a resource by the host. For example, when a user device of the host detects a WAP for the first time, the resource invitation module 211 is notified. Alternatively, the module 211 is notified at the time of direct indication of a given resource by the resource provisioning module 205. Once notified, the module 211 generates a notification message via the user interface module for a requesting that the host add the resource to the list of shared resources. It is noted that the notification message is only generated when the host is able to access the resource.

In one embodiment, the user interface module 207 enables presentment of a graphical user interface for a configuration interface, resource selection interface, invite acceptance interface, or other interfaces of the access rights platform 111. The user interface module 207 generates the interface in response to application programming interfaces (APIs) or other function calls corresponding to operating system of the user devices 101a-101n; thus enabling the display of graphics primitives.

FIG. 2B is a diagram of a data structure of access point data maintained by the access rights platform, according to one embodiment. The cross referencing module 203, resource provisioning module 205 and resource monitor 209 may operate in connection with the user interface module 207 to retrieve and/or compile the access point data 115. By way of example, the data structure 220 for maintaining access point data may include a resource identifier 223 relating to the resource to be shared, a password 225 for accessing the resource, a network location 227 (e.g., resource locator) of the resource via a communication network, a related user resource locator (URL) 229, pointer 231 to the access rights list and rules (e.g., a social networking service profile page, friendship status) and a pointer 233 to an advertisement page such as related to the host or the shared resource.

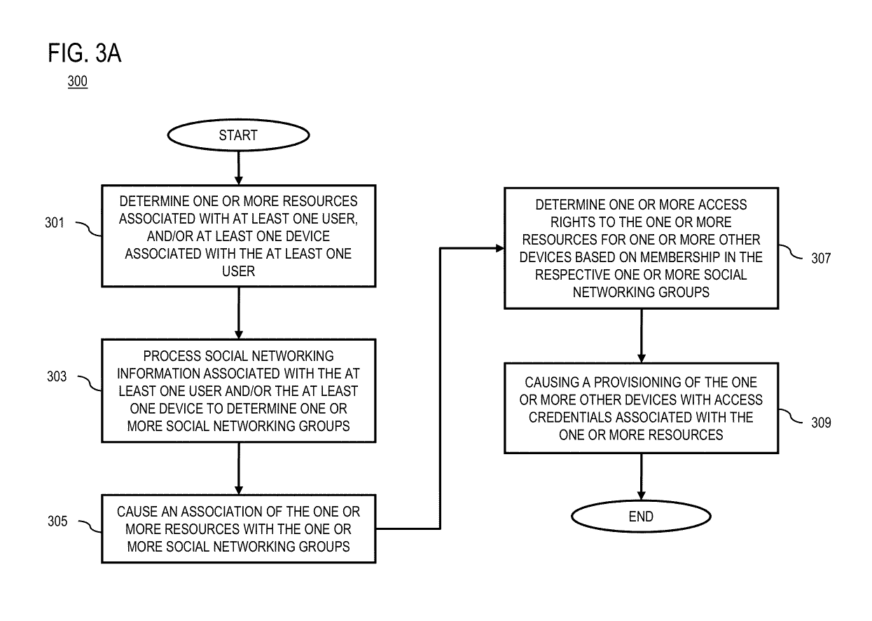

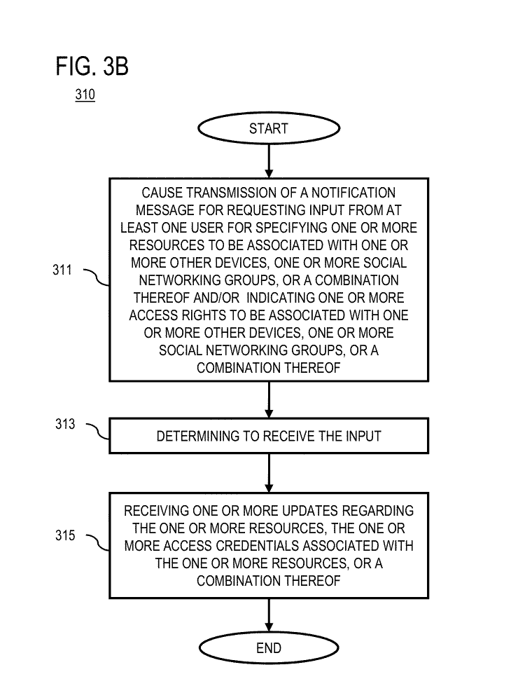

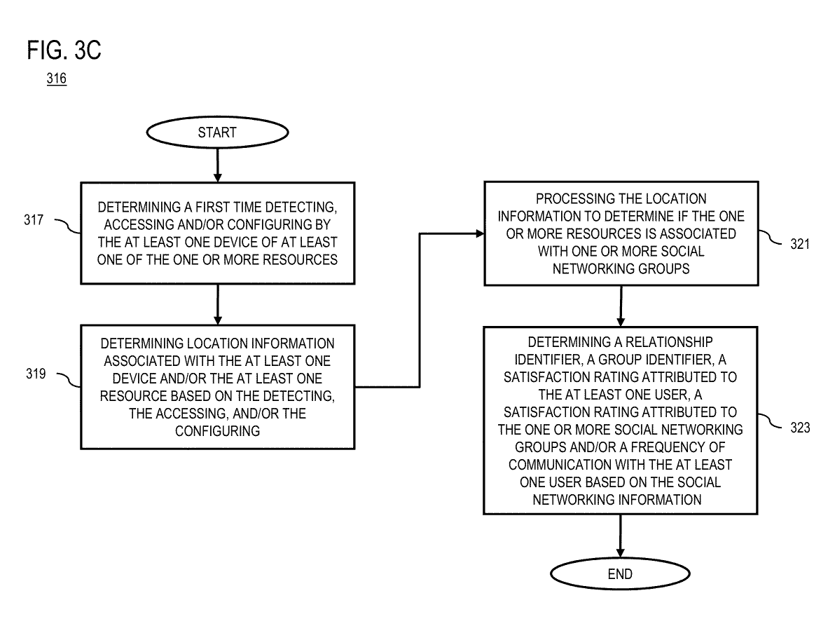

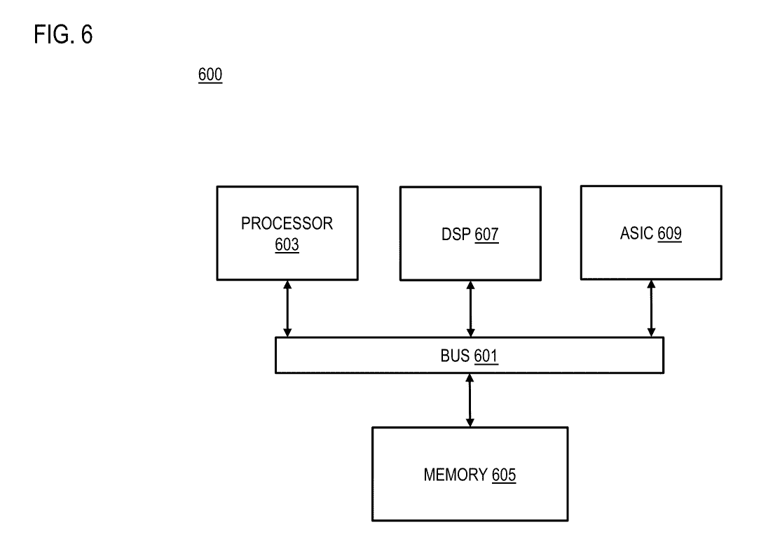

FIGS. 3A-3C are flowcharts of a process for automating the provisioning of access credentials related to one or more shared resources for one or more user devices, according to various embodiments. In one embodiment, the access rights platform 111 of FIG. 1 performs the process 300 and is implemented in, for instance, a chip set including a processor and a memory as shown in FIG. 6. In step 301, the access rights platform 111 determines one or more resources associated with at least one user (the host) and/or at least one device associated with the at least one user (the host). This corresponds to the initial registration process as performed by the host. At this time, the user may also specify one or more resources, one or more members, one or more groups and/or one or more access rights of respective members and/or groups to the resources.

Per step 303, the platform 111 processes social networking information associated with the at least one user and/or the at least one device to determine one or more social networking groups. In step 305, the platform then causes an association of the one or more resources with the one or more social networking groups, i.e., based on processing of the social networking information. For example, the association may include accessing group affiliation data specified via the users social networking profile page. In another step 307, a determination of one or more access rights to the one or more resources for one or more other devices is performed. The determination is made, based at least in part, on membership in the respective one or more social networking groups of the host. By way of example, the one or more other devices may include those belonging to friends of the host that belong to one or more of the groups associated with the host.

Per step 309, in response to the determination, the access rights platform 111 causes a provisioning of the one or more other devices with access credentials associated with the one or more specified resources. As noted previously, the provisioning may include a transmitting of the access credentials via one or more cellular data allocation techniques, push techniques, data synchronization techniques, etc. The access credentials may include, for example, a network address, a media access control identifier, a service set identifier, a key, a password, a resource locator, or a combination thereof pertaining to the one or more resources.

In step 311 of process 310 (FIG. 3B), the platform 111 causes transmission of a notification message for requesting input from at least one user for (1) specifying one or more resources to be associated with one or more other devices, one or more social networking groups, or a combination thereof, (2) indicating one or more access rights to be associated with one or more other devices, one or more social networking groups, or a combination thereof, or (3) a combination thereof. In step 313, the platform 111 determines to receive the input from the at least one user (host). In another step 315, the platform 111 also receives input for indicating one or more updates regarding the one or more resources, the one or more access credentials associated with the one or more resources, or a combination thereof.

In step 317 of process 316 (FIG. 3C), a first time detecting, accessing and/or configuring by the at least one device of at least one of the one or more resources is determined. In step 319, the platform 111 also determines location information associated with the at least one device and/or the at least one resource based on the detecting, the accessing, and/or the configuring. By way of example, the location information may be used to determine an approximate the location and availability of one or more resources of the host as well as to optimize the search of available resources. Per step 321, the platform 111 processes the location information to determine if the one or more resources are associated with one or more social networking groups. As noted previously, the host specifies the association of resources to specific members and/or groups of the social networking service as access point data.

The access point data also includes data regarding the various identifier information required for cross referencing users (members) of the social networking service with the various resources. Hence, per step 323, the platform 111 determines a relationship identifier, a group identifier, a satisfaction rating attributed to the at least one user (host), a satisfaction rating attributed to the one or more social networking groups, a frequency of communication with the at least one user (host), a guest rating as attributed to the one or more other members by the host, or a combination thereof based, at least in part, on the social networking information. It is noted, in certain embodiments, the visitation frequency may be used to determine if a user requiring access to a resource is a first time visitor or collaborator of the host, a frequent visitor or collaborator of the host, etc. Assess rights, or a level of extent thereof, may be conditioned upon the frequency of visitation or any of the other ratings, rankings and indicators capable of specification via the social networking service.

FIGS. 4A-4D are diagrams of user interfaces utilized in the processes of FIGS. 3A-3C, according to various embodiments. The diagrams are described from the perspective of use case of a host affiliated with Naes Café that configures one or more resources of the restaurant/company for use by one or more restaurant patrons. The interface descriptions may correspond to one or more of the processes of FIGS. 3A-3C. While the users (patrons) of the user devices to which access credentials are to be provisioned are different in this example, it is noted that in certain instances the other user devices may also be the host's. For example, the host may perform similar processes to enable provisioning of access credentials for all computing devices used at the restaurant.

In FIG. 4A, a configuration interface is presented to the display 401 of a device 400 of the host. In this example, the host device 400 is a tablet computer having wireless access to a communication network for accessing the access rights platform 111. The configuration interface enables the host to specify various settings of the access rights platform 111, including one or more resource access requirements 407, one or more groups 402 allowed access to the resources and the one or more resources 421 available for access. In addition, the configuration interface enables the user to establish one or more cross reference systems 409 of the host as well as any additional characteristics 417 or criteria for affecting the various access rights of one or more designated users.

The host selects from the group selection section 402, via a drop down menu 404, a group entitled “Premier Diners” to configure. By way of example, this group corresponds to only those customers representing long-time patrons of the restaurant. The host may also select a modify list link 403 or exceptions link 405 for updating the list or excluding one or more patrons from the group listing respectively. It is noted that selection of these links may render presentment of a new interface or pop-up window for making the modifications.

The access requirements selection section 407 also presents various access rights conditions for selection by the host. The host may activate a checkbox (e.g., checkbox 411) corresponding to the one or more requirements to be met by the various patrons for accessing the various resources. By way of example, a Like indicator criteria, visited within (X) days criteria and profile (Y) % complete criteria may be selected. Under this scenario, the user deselects the Like checkbox 411 to indicate that users need not meet the requirement of having indicated a Like ranking at the host's social networking page. A checkbox for indicating the patron visited the host's social networking page within the last 60 days—with the days of visitation customized by the host—is also selected. A profile completion of 80%—with the completion percentage customized by the host—is also selected. In this example, the completion percentage corresponds to the extent to which a visitor to the host's social networking page is identifiable via the social networking service (e.g., complete email, name, occupation information, etc.)

The user may also select one or more links 413-416 to Add Requirements, Delete Requirements and establish Conditions respectively. The Add link 413 enables the host to include more access requirements to the list, including those established by the host or as selected from a default access rights list as provided by the access rights platform. The Delete link 415 enables the host to remove requirements from the list. Also, the Conditions link 416 enables the host to associate the one or more access requirements with one or more conditional settings. By way of example, a location or proximity condition may be established with respect to the patrons, which upon being met enables provisioning of the resource access credentials. In this example, location information pertaining to the user device of the patron is collected and analyzed by the access rights platform 111. As another example, a condition may be set for determining a certain member of the group is currently engaged to enable activation of a data resource for all the other members. It is noted that the platform 111 may support the customization of the various conditional settings.

A cross reference systems section 409 may be provided to the host for enabling the selection of the various services 113 to be cross referenced by the access rights platform for supporting group membership authentication. By way of example, the user may select an icon 418 for enabling selection of the external cross reference sources, including one or more social networking services entitled SNS1 and SNS2. Under this scenario, cross reference processing may also be made against the restaurant point-of-sales system entitles Naes POS System. It is noted that in the case of the POS system, additional requirements and/or characteristics 417 may be established for affecting access rights to the various resources. For example, conditions that may be determined based on the processing of POS system data may include that of no outstanding charges, that the customer is on the host's mailing list, and that the patron has been with the restaurant for over 180 days. These conditions are selected for activation via one or more corresponding checkboxes, i.e., checkbox 429. It is noted that the additional characteristics 417 and access requirements 407 are encoded as or maintained as an access rights file, which may be maintained in the access point database or referenced by pointer via the access rights platform 111.

A resource selection section 421 enables the host to select one or more resources to be made available to the members of the Premier Diners group indicated in the group selection section 402. Under this scenario, the resources include the host WiFi hotspot (e.g., WAP), a data source for storing coupon data entitled a Coupon Vault, and an executable application for playing music exclusive to the restaurant entitled Luna Music Application. The host may also add or delete one or more resources from the list via Add and Delete links 420 and 422 respectively. Still further, the user may select a Modify Credentials link 419 corresponding to each listed resource for updating the various access credentials of the resource (e.g., password, resource locator, etc.).

Once the configurations are made, the host can save the configuration for the selected group (Premier Diners) by selecting a “SAVE” action button 423. Alternatively, the host can cancel the configuration settings by selecting a “CANCEL” action button 425. Still further, the host can select a “CONFIGURE ANOTHER” action button 427 to enable configuration of another group. While the example configuration in FIG. 4A depicts only the Premier Diners group, it is noted that other groups may also be simultaneously configured. For example, an Exclusive Customers group may also be selected via the drop down menu 404.

A user device 430 corresponding to a patron of the restaurant is shown in FIG. 4B pursuant to the configuration settings established by the host. Under this scenario, the user is determined to have met the various access rights and conditional settings established by the host. When the user is within access of the WAP of the restaurant, the access rights platform 111 causes the display to render a notification message 432 for indicating the resource was detected. The display 431 also presents host information, including the name of the host of the resource (Naes Café) and an icon 433 representing with the host. The icon 433 may correspond to that featured at the social networking service for easy recognition by the patron. In response to the notification, the patron can select a “YES” or “NO” action button 435 and 437 respectively.

Upon selecting the “YES” action button 435, the authentication process is further carried out by the access rights platform. By way of example, this includes an automated invoking a social networking profile page 439 of the host that provided the resource, as shown with respect to FIG. 4C. Under this scenario, the social networking profile page 439 corresponds to that of Naes Café. As noted previously, rendering of the page 439 is executed responsive to the automated logging in of the user John to the SNS. The authentication steps further enable correlation between the host, the user and the various resources to be accessed.

The access credentials required by the patron to access the WAP of the host are provisioned upon successful completion of the authentication process. Once the credentials are provisioned to the device of the patron, the patron is able to access the WAP of the host. A resource access notification 441 as rendered to the display of the patron's user device (not shown) is depicted in FIG. 4D. The notification 441 includes a welcome message 443, an icon 445 for representing the host and one or more offers 447 made available to the patron. The patron may select a “CLOSE WINDOW” or “DO NOT SHOW THIS NEXT TIME” action button 449 and 451 respectively to close out the notification message or opt out of receipt of such notifications in the future.

The processes described herein for automating the provisioning of access credentials related to one or more shared resources to one or more user devices may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

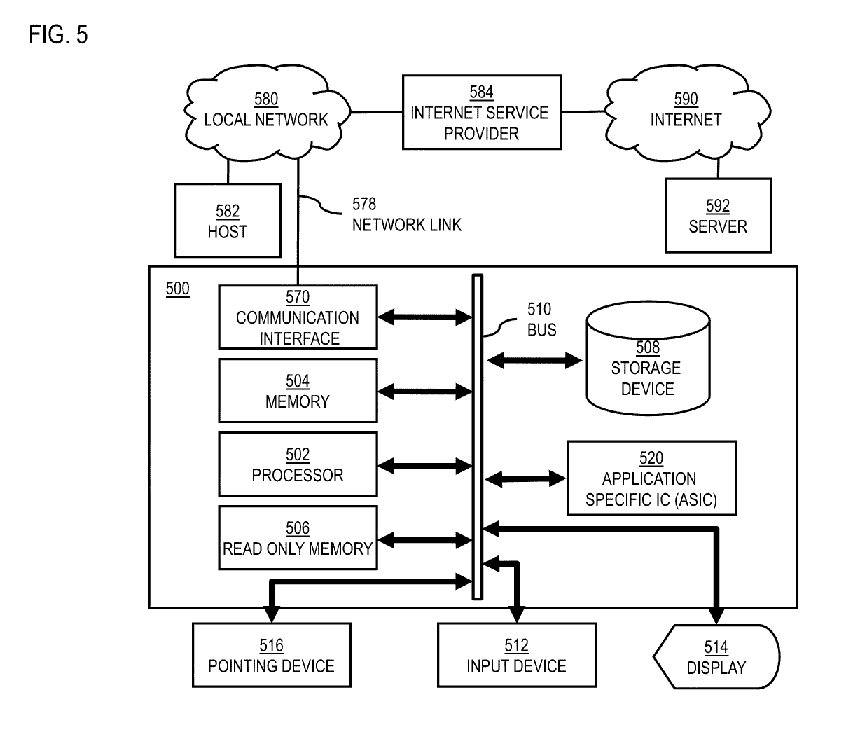

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to automate the provisioning of access credentials related to one or more shared resources to one or more user devices as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps to automating the provisioning of access credentials related to one or more shared resources to one or more user devices.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to automate the provisioning of access credentials related to one or more shared resources to one or more user devices. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for automating the provisioning of access credentials related to one or more shared resources to one or more user devices. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for automating the provisioning of access credentials related to one or more shared resources to one or more user devices, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for automating the provisioning of access credentials related to one or more shared resources to one or more user devices to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to automate the provisioning of access credentials related to one or more shared resources to one or more user devices as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps to automating the provisioning of access credentials related to one or more shared resources to one or more user devices.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to automate the provisioning of access credentials related to one or more shared resources to one or more user devices. The memory 605 also stores the data associated with or generated by the execution of the inventive steps.

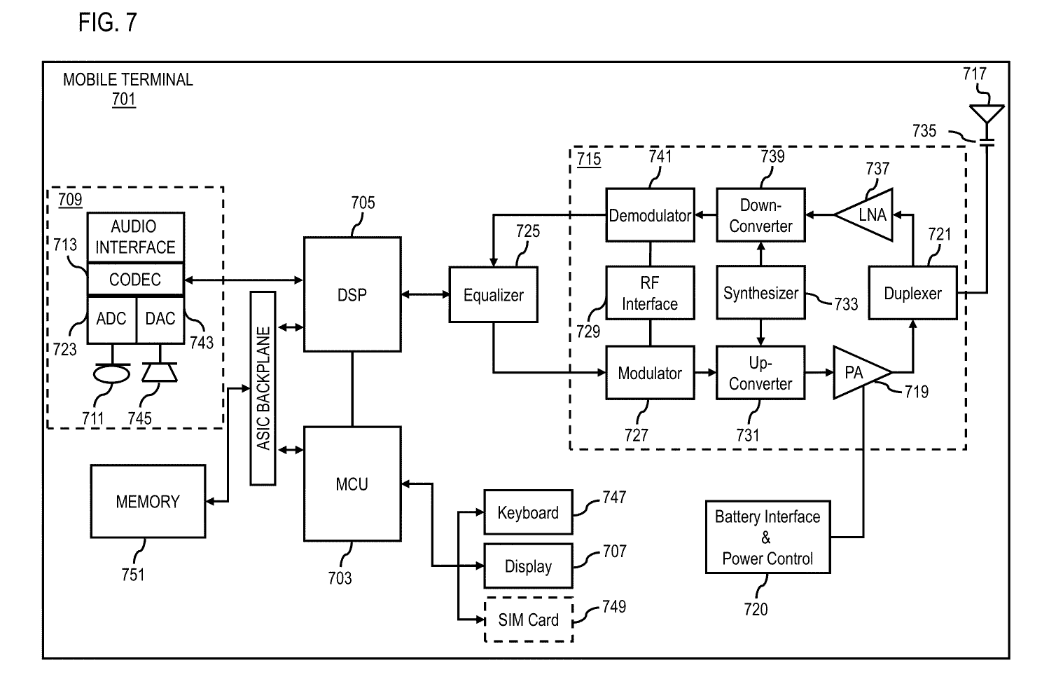

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps to automating the provisioning of access credentials related to one or more shared resources to one or more user devices. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps to automating the provisioning of access credentials related to one or more shared resources to one or more user devices. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to automate the provisioning of access credentials related to one or more shared resources to one or more user devices. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more resources associated with at least one user, at least one device associated with the at least one user, or a combination thereof;
a processing of social networking information associated with the at least one user, the at least one device, or a combination thereof to determine one or more social networking groups;
an association of the one or more resources with the one or more social networking groups; and
at least one determination of one or more access rights to the one or more resources for one or more other devices based, at least in part, on membership in the respective one or more social networking groups.

2. A method of claim 1, wherein the (1) data and/or (2) information and/or (3) at least one signal are further based, at least in part, on the following:
a provisioning of the one or more other devices with access credentials associated with the one or more resources.

3. A method of claim 2, wherein the access credentials include a network address, a media access control identifier, a service set identifier, a key, a password, a resource locator, or a combination thereof.

4. A method of claim 1, wherein the at least one determination of the one or more resources causes the (1) data and/or (2) information and/or (3) at least one signal to be further based, at least in part, on the following:
a notification message for requesting input from at least one user for (1) specifying one or more resources to be associated with one or more other devices, one or more social networking groups, or a combination thereof, (2) indicating one or more access rights to be associated with one or more other devices, one or more social networking groups, or a combination thereof, or (3) a combination thereof.

5. A method of claim 4, wherein the (1) data and/or (2) information and/or (3) at least one signal are further based, at least in part, on the following:
at least one determination of a first time detecting, accessing, configuring, or a combination thereof by the at least one device of at least one of the one or more resources;
at least one determination of location information associated with the at least one device, the at least one resource, or a combination thereof based, at least in part, on the detecting, the accessing, the configuring, or a combination thereof; and
a processing of the location information to determine if the one or more resources are associated with one or more social networking groups.

6. A method of claim 1, wherein the at least one determination of the one or more access rights causes the (1) data and/or (2) information and/or (3) at least one signal to be further based, at least in part, on the following:
at least one determination of a relationship identifier, a group identifier, a satisfaction rating attributed to the at least one user, a satisfaction rating attributed to the one or more social networking groups, a frequency of communication with the at least one user, a guest rating, or a combination thereof based, at least in part, on the social networking information.

7. A method of claim 6, wherein the one or more access rights corresponds to a level of access to the one or more resources.

8. A method of claim 1, wherein the (1) data and/or (2) information and/or (3) at least one signal are further based, at least in part, on the following:
one or more updates regarding the one or more resources, the one or more access credentials associated with the one or more resources, or a combination thereof.

9. A method of claim 1, wherein the one or more resources include one or more access points, one or more data resources, one or more executables, or a combination thereof.

10. An apparatus comprising:
at least one processor; and
at least one memory including computer program code for one or more programs,
the at least one memory and the computer program code configured to, with the at least one processor, cause the apparatus to perform at least the following,
determine one or more resources associated with at least one user, at least one device associated with the at least one user, or a combination thereof;
process and/or facilitate a processing of social networking information associated with the at least one user, the at least one device, or a combination thereof to determine one or more social networking groups;
cause, at least in part, an association of the one or more resources with the one or more social networking groups; and
determine one or more access rights to the one or more resources for one or more other devices based, at least in part, on membership in the respective one or more social networking groups.

11. An apparatus of claim 10, wherein the apparatus is further caused to:
cause, at least in part, a provisioning of the one or more other devices with access credentials associated with the one or more resources.

12. An apparatus of claim 11, wherein the access credentials include a network address, a media access control identifier, a service set identifier, a key, a password, a resource locator, or a combination thereof.

13. An apparatus of claim 10, wherein the step of determining the one or more resources further causes the apparatus to:
cause, at least in part, a transmission of a notification message for requesting input from at least one user for (1) specifying one or more resources to be associated with one or more other devices, one or more social networking groups, or a combination thereof, (2) indicating one or more access rights to be associated with one or more other devices, one or more social networking groups, or a combination thereof, or (3) a combination thereof.

14. An apparatus of claim 13, wherein the apparatus is further caused to:
determine a first time detecting, accessing, configuring, or a combination thereof by the at least one device of at least one of the one or more resources;
determine location information associated with the at least one device, the at least one resource, or a combination thereof based, at least in part, on the detecting, the accessing, the configuring, or a combination thereof; and
process and/or facilitate a processing of the location information to determine if the one or more resources are associated with one or more social networking groups.

15. An apparatus of claim 10, wherein the step of determining the one or more access rights further causes the apparatus to:
determine a relationship identifier, a group identifier, a satisfaction rating attributed to the at least one user, a satisfaction rating attributed to the one or more social networking groups, a frequency of communication with the at least one user, a guest rating, or a combination thereof based, at least in part, on the social networking information.

16. An apparatus of claim 15, wherein the one or more access rights corresponds to a level of access to the one or more resources.

17. An apparatus of claim 10, wherein the apparatus is further caused to:
receive one or more updates regarding the one or more resources, the one or more access credentials associated with the one or more resources, or a combination thereof.

18. An apparatus of claim 10, wherein the one or more resources include one or more access points, one or more data resources, one or more executables, or a combination thereof.

19. A computer-readable storage medium carrying one or more sequences of one or more instructions which, when executed by one or more processors, cause an apparatus to perform:
determining one or more resources associated with at least one user, at least one device associated with the at least one user, or a combination thereof;
processing and/or facilitating a processing of social networking information associated with the at least one user, the at least one device, or a combination thereof to determine one or more social networking groups;
causing, at least in part, an association of the one or more resources with the one or more social networking groups; and
determining one or more access rights to the one or more resources for one or more other devices based, at least in part, on membership in the respective one or more social networking groups.

20. A computer-readable storage medium of claim 19, wherein the apparatus is further caused to perform:
causing, at least in part, a provisioning of the one or more other devices with access credentials associated with the one or more resources.

21-46. (canceled)
